(19) United States
(12) Patent Application Publication
(10) Pub. No.: US 2006/0016535 A1
(43) Pub. Date: Jan. 26, 2006

(54) Lubricating composition for a tire safety support

(75) Inventors: Jean-Louis Mauclin, Pont-Du-Chateau (FR); Georges Salaun, Nohanent (FR); Laure Simonot, Greenville, SC (US)

Correspondence Address: FITZPATRICK CELLA HARPER & SCINTO, 30 ROCKEFELLER PLAZA, NEW YORK, NY, 10112, US

(73) Assignee: Michelin Recherche Et Technique S.A., Granges-Paccot (CH)

(21) Appl. No.: 11/197,672

(22) Filed: Aug. 3, 2005

(30) Foreign Application Priority Data
Feb. 4, 2003 (FR) 03/01288
Feb. 2, 2004 (WO) PCT/EP04/00919

(51) Int. Cl. B60C 17/04; C10M 145/34; C10M 113/12; B60C 17/10

(52) U.S. Cl. 152/158; 508/136; 508/579; 152/521; 152/520

(57) ABSTRACT

The present invention concerns a lubricant composition that can be used to lubricate an interface between a tire and a safety support mounted on a wheel rim inside the tire, the tire and a mounted assembly for an automotive vehicle being provided with the lubricant composition, wherein the lubricant composition according to the invention is characterized in that it comprises an alkene oxide polymer (polyoxyalkene) as the lubricating agent and between 4.0% and 7.5% (% by weight of the lubricant composition) of silica as a thickening agent.

### CROSS REFERENCE TO RELATED APPLICATIONS

This application is a continuation of International Patent Application No. PCT/EP2004/000919, filed Feb. 2, 2004, which claims priority to French Patent Application No. FR 03/01288, filed Feb. 4, 2003, both of which are incorporated by reference in their entireties.

### BACKGROUND OF THE INVENTION

1. Field of the Invention

The present invention concerns a lubricant composition that can be used to lubricate an interface between a tire and a safety support fitted on a wheel rim inside the tire, and to such a tire and a mounted assembly for an automotive vehicle provided with the lubricant composition. The invention also concerns the lubrication between the support and the tire when running flat after a drop in the inflation pressure inside the tire.

2. Description of Related Art

When a tire is running at low or zero pressure (known as running “flat”), to delay the deterioration by heating of the friction zones between various parts of the inside face of the tire or between the latter and the metallic wheel rim, in the past it has been sought to provide the inside face of the tire with a lubricant composition designed to reduce the friction between these friction zones.

These tire/tire or rim/tire lubricant compositions comprise, in a known way:
a lubricating agent such as an alkene oxide polymer (or polyoxyalkene) or glycerine;
a thickening agent such as silica, intended to raise the viscosity of the lubricating agent so as to minimize the flow of the lubricating agent due to gravity when the vehicle is at rest or rolling with its tires inflated;
one or more volatile liquids which can vaporize during running flat, such as water, an alcohol or a salt in aqueous solution; and
a surfactant reinforcement agent, also in aqueous solution.

As an example one can cite patent document FR-A-2 293 486 (or U.S. Pat. No. 4,051,884), which presents a lubricant composition designed to lubricate the tire/tire or tire/wheel interface, which comprises a lubricating agent, a thickening agent, a volatile liquid and a surfactant reinforcement agent. The lubricating agent in this composition consists of a polyoxyalkene, preferably a copolymer of ethylene oxide and propylene oxide. The thickening agent used is a finely divided silica whose mass fraction in the lubricant composition must be at least 7.5%. This mass fraction ranging from 8.4% to 9.0% in actual examples. The lubricating agent also contains water as the volatile liquid intended to lower the relatively high viscosity of the copolymer. Finally, the surfactant reinforcement agent consists of an ionic salt of an alkali metal with pH between 5.5 and 8.5 in aqueous solution.

One can also cite U.S. Pat. No. 3,946,783, which presents a lubricant composition designed to lubricate the tire/wheel interface. This composition comprises non-volatile agents intended to be accommodated inside the tire casing, any known lubricating agents (such as water, oils, esters, silanes, surfactants, polyoxyalkene glycols, glycol ethers, polymers of chlorofluorocarbon or silicones), one or more thickening agents that comprise organic or inorganic inert fillers (such as silicates, asbestos fibres, silica, derivatives of cellulose or polyamides) and, volatile agents intended to be held in a reservoir mounted on the wheel that are to be released when running flat so that they can mix with the non-volatile agents. Preferably water and a surfactant are included.

More recently, it has been sought to improve the endurance of the mounted assemblies under conditions of running at low or zero inflation pressure, by providing a specific safety support inside the tire, fitted on the wheel rim so as to be able to support the tread of the tire if the inflation pressure drops. For a description of such supports, one can cite for example, patent documents FR-A-2 746 347 (or U.S. Pat. No. 5,891,279) or WO 00/76791 (or U.S. Pat. No. 6,564,842).

In this context support/tire lubricant compositions have been tested which are specifically designed to reduce the friction between the support and the inside face of the tire surrounding it, under flat running conditions, heavier loading and for times considerably longer than those typical of the previous tests without the safety support. These compositions are usually applied to the inside face of the tire before the latter is mounted on the rim.

Patent document FR-A-2 480 201 (or GB-A-2 074 955) presents a support/tire lubricant composition comprising, in a mass fraction of about 70%, a lubricating agent consisting of a polyglycol and, in a mass fraction of about 30%, a thickener comprising a large number of solid particles including rubber powder, glass and plastic spherules, and optionally a silicon oxide.

Patent document FR-A-2 415 551 (or GB-A-2 013 143) also presents a support/tire lubricant composition comprising a lubricating agent consisting for example of a polypropylene glycol and a thickener comprising rubber and ground-up tire cables, fibrous elements such as asbestos, and silica.

More recently, international patent application WO 02/04237 (or U.S. Patent Application Publication No. 2003/0087766) disclosed a support/tire lubricant composition containing a lubricating agent and a polysaccaride designed to thicken the lubricating agent, the lubricating agent containing at least 60% by weight of glycerine and being present in the composition in a mass fraction of between 95% and 99%.

The purpose of the present invention is to propose a new lubricant composition that can be used to lubricate the interface between a tire and a safety support fitted on a wheel rim inside the tire.

The Applicants discovered that, unexpectedly, the association in the lubricant composition of a lubricating agent comprising an alkene oxide polymer with a small proportion of silica as a thickening agent, in a narrow range between 4.0% and 7.5% (% by weight of the lubricant composition) makes it possible to prevent the flow of the composition before flat running and to ensure that during flat running both the lubrication and the endurance are improved compared with those achieved by the known lubricant compositions. These results can also be obtained by using smaller amounts of the lubricant composition.

The invention also concerns the use of a lubricant composition according to the invention to lubricate an interface between an automotive vehicle tire and a safety support fitted on a wheel rim inside the tire.

The invention also concerns a tire comprising a radially inner face designed to be opposite a wheel rim on which it is designed to be fitted, and such that the radially inner face is provided with a lubricant composition according to the invention.

The invention also concerns a mounted assembly according to the invention for an automotive vehicle comprising a rim, a safety support fitted on the rim and at least the radially outer face of which consists of a rubber composition or a plastic material, and a tire mounted on the rim around the support, the rim having at each of its two peripheral edges a rim seat on which is fitted a bead of the tire, the rim also comprising between its two seats a bearing surface that receives the support. This mounted assembly is characterized by being provided with the lubricant composition according to the invention designed to lubricate the tire/safety support interface.

Preferably, the mounted assembly according to the invention is provided with the lubricant composition on the radially inner face of the tire opposite the rim.

### BRIEF DESCRIPTION OF THE DRAWINGS

The invention will be easily understood in the light of the detailed description given below and the attached figures, which show:

FIG. 1 is a side view of a safety support designed to form part of a mounted assembly according to the invention; and

FIG. 2 is an axial cross-section of a mounted assembly according to the invention, in which the support of FIG. 1 is fitted on a wheel rim and is positioned in contact against a tire.

### DETAILED DESCRIPTION OF THE INVENTION

In the lubricant composition according to the invention, the proportion (or mass fraction) of silica must be higher than 4.0% and lower than 7.5%, otherwise the endurance levels during flat running required for the mounted assemblies of the invention are not reached. For that reason, the proportion of silica is preferably within a range from 5.3% to 6.7% and more preferably still within a range from 5.5% to 6.5%. A mass fraction of silica equal to about 6.0% (e.g., 6±0.3%) has been found optimum in numerous cases.

The silica used is any silica familiar to those with knowledge of the field. For example, a precipitated or preferably pyrogenic silica with specific BET and CTAB surface areas preferably below 450 m²/g may be used.

In the present description the BET specific surface area (“area per unit mass”) is determined by gas adsorption using the Brunauer-Emmett-Teller method described in “The Journal of the American Chemical Society”, Vol. 60, p. 309, February 1938, and more precisely in accordance with French standard NF ISO 9277 of December 1996 [multipoint volumetric method (5 points)—gas: nitrogen—degassing: 1 hour at 160°—relative pressure range p/pₒ: 0.05 to 0.17]. The CTAB specific surface area is the external surface area determined in accordance with French standard NF T 45-007 of November 1987 (method B).

More preferably, the silica used has a BET surface area of between 50 and 350 m²/g. Above 350 m²/g the endurance of the mounted assembly according to the invention may deviate from the optimum, whereas the reinforcement of the composition risks being affected below 50 m²/g. Accordingly, it is best to choose a silica with a BET surface area between 100 and 250 m²/g, particularly when the safety support is one made of a diene elastomer such as natural rubber, or a polyurethane elastomer.

The polyoxyalkylene (or polyoxyalkene) used is preferably a polyalkylene glycol. Furthermore, the alkylene (or alkene) is preferably chosen from among ethylene, propylene and butylene.

It is advantageous to use a copolymer or a mixture of ethylene oxide and propylene oxide polymers. For the case of such a copolymer, the latter comprises units resulting from ethylene oxide in a preferred mole fraction of 40% to 80% (in particular 50% to 70%), and units resulting from propylene oxide in a preferred mole fraction of 20% to 60% (in particular 30% to 50%).

According to another preferred embodiment of the invention, the polyoxyalkene has a number-average molecular weight (denoted Mn) between 1,000 and 10,000 g/mol and more preferably between 2,000 and 6,000 g/mol. On the other hand its polymolecularity index (denoted Ip) is preferably below 1.5 and more preferably less than 1.3 (Ip=Mw/Mn where Mw is the weight-average molecular weight).

According to another preferred embodiment of the invention, the polyoxyalkene used has an apparent viscosity between 100 and 1,500 mPa.s (1 mPa.s=1 cP), and more preferably between 200 and 1,000 mPa.s. The viscosity is measured at 23° C. in accordance with European and international standard EN ISO 2555 (June 1999) (viscosity by the Brookfield method: rotating viscometer of type A; rotation speed 20 r/min; mobile No. 2; model RVT).

Advantageously, a polyoxyalkene of the water-soluble type is used. This makes it possible if need be, to remove the product, for example from the mounted assembly, simply by washing it with water.

In light of the description and example embodiments below, those with knowledge of the field will easily be able to control the viscosity of the lubricant composition by adjusting the lubricating agent, as a function of the particular implementation conditions of the invention, in particular the nature and geometry of the safety support, in order to avoid:
the risk, due to excessively high fluidity, of a parasitic drainage of the composition while at rest, this drainage being prone to generate a wheel-balance problem during subsequent running under normal conditions (at the intended inflation pressure);
the risk, due to excessively low fluidity, of non-uniform distribution of the composition around the safety support under flat running conditions, with an adverse effect on the overall endurance of the mounted assembly.

Of course, this viscosity adjustment is carried out while complying with the required silica concentration range (between 4.0% and 7.5%), so as not to penalize the endurance of the mounted assembly in flat running conditions.

Thus, it is advantageous to use a polyoxyalkene of viscosity within the range from 300 to 700 mPa.s, for example from 400 to 650 mPa.s, particularly when the safety support is made of a diene elastomer such as natural rubber.

Higher viscosity ranges, for example from 450 to 850 mPa.s, are also suitable for the invention, for example in the case of safety supports made of polyurethane elastomer.

Another advantageous characteristic of the lubricant composition according to the invention is that it does not require the presence of water, which favors the interaction of the lubricating agent (polyoxyalkene) with the thickening agent (silica). It is for this reason that it can be called “non-aqueous” or of the non-aqueous type, even though it can tolerate the presence of a small amount of water without ill effect. In the present application “non-aqueous” composition is understood to mean a composition preferably containing less than 2% and more preferably less than 1% by weight of water (% by weight of the lubricant composition).

Preferably, the composition according to the invention is also devoid of any other volatile liquid that vaporizes at a temperature lower than or equal to 150° C., such as an alcohol or a salt (such as an alkali metal salt).

Note that the lubricant composition according to the invention can also contain one or more different additives such as an antioxidant, coloring, bactericidal, ionic or non-ionic surfactant additives, the content of such additives being preferably lower than 2% (% by weight of the composition).

In an advantageous embodiment of the invention wherein at least the radially outer face of the support consists of a rubber composition, the latter is based on a (natural or synthetic) diene elastomer (or rubber) such as natural rubber or an elastomeric polyurethane. Advantageously, the support used is one whose elastomer matrix comprises natural rubber or polyurethane, either for the most part or exclusively.

In another advantageous embodiment of the invention wherein at least the radially outer face of the support consists of a plastic material, the latter is based on a thermosetting polyurethane (TPU) or a thermoplastic elastomer (TPE). Advantageously, the support used is one whose plastic matrix comprises such a polyurethane or such an elastomer, either for the most part or exclusively.

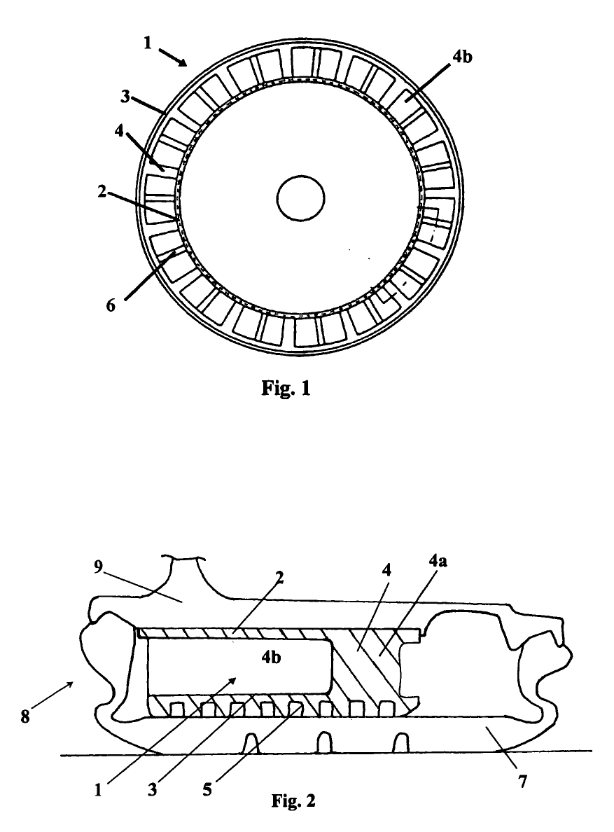

Referring to FIGS. 1 and 2, each support 1 tested in the examples that follow comprises essentially, as described in particular by the documents FR-A-2 746 347 (U.S. Pat. No. 5,891,279) or WO 00/76791 (U.S. Pat. No. 6,564,842) cited earlier:
a base 2, of generally annular shape;
a crown 3, essentially annular, (optionally) having longitudinal grooves 5 on its radially outer face, and
an annular body 4 joining the base 2 and the crown 3.

In particular, FIG. 2 illustrates the function of a support 1 which has to support the tread 7 of the tire 8 (mounted on its rim 9) in the event of a large drop in the inflation pressure of the tire.

The sectional view shown in FIG. 2 illustrates a particular example of such a support 1, with a first solid part 4a of the annular body 4 and a second part 4b containing recesses (see also FIG. 1) that extend axially over substantially more than half the annular body 4, opening on the outside in an essentially axial direction. These recesses 4b are distributed regularly all round the circumference of the annular body 4 and define partitions 6 which connect the crown 3 radially and directly to the base 2 of the support 1.

This geometry has the advantage of causing the partitions 6 to bend but not be compressed when they are crushed. The recesses 4b and so therefore the partitions 6 too are sufficiently numerous to ensure regular support when the tire is running on its support.

In the example embodiments that follow, the characteristic dimensions of each support 1, in mm (respectively width—inside diameter—height) are 115-420-45. Each support 1 is based on natural rubber and contains a highly dispensible silica as the reinforcing filler.

### Test 1

In this first test, five (5) lubricant compositions according to or not according to the invention, denoted C-1 to C-5 are prepared with the following lubricating agents:
C-1 (control): technical glycerine (90% purity);
C-2 (invention): copolymer of ethylene oxide and propylene oxide marketed by the company Uniquema under the name “EMKAROX VG 217W” (viscosity=440 mPa.s—Mn=4400 g/mol—Mw=4900 g/mol, Ip=1.11—mole fractions of ethylene oxide and propylene oxide units respectively 58% and 42%);
C-3 (invention): copolymer of ethylene oxide and propylene oxide marketed by the company Uniquema under the name “EMKAROX VG 379W” (viscosity=650 mPa.s—Mn=5500 g/mol—Mw=6800 g/mol. Ip=1.25—mole fractions of ethylene oxide and propylene oxide units respectively 59% and 41%);
C-4 (invention): copolymer of ethylene oxide and propylene oxide marketed by the company Uniquema under the name “EMKAROX VG 650W” (viscosity=850 mPa.s);
C-5 (invention): copolymer of ethylene oxide and propylene oxide marketed by the company Uniquema under the name “EMKAROX VG 1051 W” (viscosity=1400 mPa.s—Mn=8400 g/mol—Mw=10900 g/mol. Ip=1.30—mole fractions of ethylene oxide and propylene oxide units respectively 62% and 38%).

The viscosity of each lubricant was measured in accordance with the standard EN ISO 2555, as indicated earlier. The macrostructure (Mw and Mn) was determined by steric exclusion chromatography at 35° C. (solvent tetradrofuran at flow rate 1 ml/min; concentration 1 g/l; polystyrene mass calibration; detector consisting of a differential refractometer). The mole fractions of ethylene oxide and propylene oxide units were determined by NMR.

Each of these compositions further comprises, as the thickening agent, 5.4% of pyrogenic silica with a BET surface area between 100 and 250 m²/g (known as “CAB-O-SIL® M-5” from the company Cabot—BET=200 m²/g). In these examples no additives were added to lubricant compositions C-1 to C-5, which therefore consist simply of the combination of the plasticising agent and silica.

Identical tires were provided with compositions C-1 to C-5, applying the latter in determined masses to a median zone of the inside face of the corresponding tire, a zone essentially having as its plane of symmetry the equatorial plane of the tire. The tires were then mounted on identical rims such as that illustrated in FIG. 2, on which identical safety supports such as that described earlier in relation to FIGS. 1 and 2 had previously been fitted.

The characteristic dimensions of each mounted assembly so obtained, designed for fitting to a “RENAULT” automotive vehicle (“SCENIC” model), are in mm: 185-620-420 (respectively, tire width, tire diameter, and rim diameter).

For the purposes of the test, a puncture 6 mm in diameter was then made half-way along the width of the tread of the tire included in each mounted assembly, radially inside the bottom of a tread groove.

Successive running tests were then carried out on these vehicles, one of whose mounted assemblies (front right), comprising one of the lubricant compositions C-1 to C-5, ran flat from the beginning of each test because of the prior puncture.

In each test the particular conditions of this flat running were as follows: load on the wheel 450 kg; average running speed 100 km/h; ambient temperature during running 25° C.; running on a motorway-type circuit. The termination criterion in each test is the number of kilometers travelled before the destruction of the safety support and/or the tire.

The results obtained are shown in Table 1 below.

TABLE 1

| | Viscosity of | Mass of the | Flat running |
|---|---|---|---|
| | lubricating agent | lubricant | endurance |
| Composition No. | (mPa · s): | composition (g): | (km travelled): |
| C-1 | 150 | 80 | 50 |
| C-2 | 440 | 60 | 290 |
| C-3 | 650 | 60 | 250 |
| C-4 | 850 | 80 | 230 |
| C-5 | 1400 | 200 | 270 |

These results clearly demonstrate the superiority of compositions C-2 to C-5 according to the invention, when compared with the control composition C-1. Each of the mounted assemblies according to the invention covered a distance greater than 200 km, which is a very clear improvement when compared with the mounted assembly of the prior art comprising glycerine as the lubricating agent.

Of course, the endurance result obtained for each mounted assembly is better, the greater the number of kilometers covered and the smaller the mass of lubricant composition used. From this standpoint, it should be noted that the best results here are obtained with mounted assemblies provided with a very small amount (60 g per tire) of compositions C-2 and C-3, comprising as a lubricating agent a polyoxyalkene whose viscosity is in the recommended preferred range of 300 to 700 mPa.s for supports made of diene elastomer.

### Test 2

In the second test, five (5) new lubricant compositions denoted C-6 to C-10, according to or not according to the invention are prepared, which have a variable proportion of thickening agent (“CAB-O-SIL® M-5” silica) as indicated in Table 2. Thus, only compositions C-7 and C-8 comprising a silica content higher than 4.0% and lower than 7.5% (by weight of the lubricant composition), conform to the invention.

The lubricating agents in this test are the products “EMKAROX VG 217W” and “EMKAROX VG 379W” used in the previous test. In these examples no additives were added to the lubricant compositions, which therefore simply consist of the combination of the plasticising agent and silica.

The compositions were tested in flat running as indicated earlier for Test No. 1 (using only 60 g of lubricant composition per tire). The results are shown in Table 2 below.

TABLE 2

| | | Viscosity of | Flat running |
|---|---|---|---|
| | Proportion of | lubricating agent | endurance |
| Composition No. | silica (%) | (mPa · s) | (km travelled) |
| C-6 | 4.0 | 440 | 155 |
| C-7 | 5.4 | 440 | 290 |
| C-8 | 6.0 | 440 | 300 |
| C-9 | 8.0 | 650 | 130 |
| C-10 | 10.0 | 650 | 40 |

These results fully confirm those of the previous test, namely that the compositions according to the invention (C-7 and C-8) confer on the mounted assemblies an endurance considerably greater than 200 km, whereas the compositions C-6 on the one hand and C-9 and C-10 on the other, by comparison, result in a lower endurance despite—as must be stressed—an identical lubricating agent and a very similar proportion of silica.

In conclusion, the lubricant compositions according to the invention confer on the mounted assemblies of the invention a lubricating effect and hence flat running endurance, which are much better, even with a substantially smaller amount of lubricant composition applied.

Thus, the mounted assemblies of the invention have the advantageous and preferred characteristic that they contain less than 200 g and more preferably, less than 150 g of lubricant composition. In many cases, as demonstrated in the above examples, the quantity of lubricant composition is even less than 100 g.

What is claimed is:

1. A lubricant composition usable to lubricate an interface between a tire and a safety support fitted on a wheel rim inside the tire, wherein the lubricant composition comprises a polyoxyalkene as the lubricating agent, and between 4.0% and 7.5%, by weight, of silica as a thickening agent.

2. The composition according to claim 1, wherein the polyoxyalkene is a polyoxyalkene glycol.

3. The composition according to claim 1, wherein the polyoxyalkene has an alkene portion selected from the group consisting of ethylene, propylene and butylene.

4. The composition according to claim 3, wherein the polyoxyalkene is a copolymer or a mixture of polymers of ethylene oxide and propylene oxide.

5. The composition according to claim 4, wherein the polyoxyalkene is a copolymer of ethylene oxide and propylene oxide, the copolymer comprising units resulting from ethylene oxide in a mole fraction from 40% to 80% and units resulting from propylene oxide in a mole fraction of 60% to 20%.

6. The composition according to claim 1, wherein the polyoxyalkene has a number-average molecular weight of between 1,000 and 10,000 g/mol.

7. The composition according to claim 6, wherein the polyoxyalkene has a polymolecularity index lower than 1.5.

8. The composition according to claim 1, wherein the polyoxyalkene has an apparent viscosity (measured in accordance with European standard EN ISO 2555) between 100 and 1,500 mPa.s.

9. The composition according to claim 8, wherein the polyoxyalkene has an apparent viscosity of between 200 and 1,000 mPa.s.

10. The composition according to claim 9, wherein the polyoxyalkene has an apparent viscosity in the range 450 to 850 mPa.s.

11. The composition according to claim 9, wherein the polyoxyalkene has an apparent viscosity in the range 300 to 700 mPa.s.

12. The composition according to claim 11, wherein the polyoxyalkene has an apparent viscosity in the range 400 to 650 mPa.s.

13. The composition according to claim 1, wherein the mass fraction of silica is in the range 5.3% to 6.7%.

14. The composition according to claim 13, wherein the mass fraction of silica is in the range 5.5% to 6.5%.

15. The composition according to claim 14, wherein the mass fraction of silica is about 6.0%.

16. The composition according to claim 1, wherein the silica has a BET specific surface area of less than 450 m²/g.

17. The composition according to claim 16, wherein the silica has a BET specific surface area between 50 and 350 m²/g.

18. The composition according to claim 17, wherein the silica has a BET specific surface area between 100 and 250 m²/g.

19. The composition according to claim 1, wherein the silica is a pyrogenic silica.

20. A tire comprising a radially inner face designed to be opposite a wheel rim on which it is designed to be mounted, wherein the radially inner face is provided with a lubricant composition comprising a polyoxyalkene as a lubricating agent, and between 4.0% and 7.5%, by weight, of silica as a thickening agent.

21. A mounted assembly for an automotive vehicle, comprising a wheel rim, a safety support fitted on the rim and at least the radially outer face of which comprises a rubber composition or a plastic material, and a tire mounted on the rim around the support, the rim having at each of its two peripheral edges a rim seat on which is mounted a bead of the tire, the rim comprising between the rim's two seats a bearing surface to receive the support, wherein the mounted assembly is provided with a lubricant composition comprising a polyoxyalkene as a lubricating agent, and between 4.0% and 7.5%, by weight, of silica as a thickening agent, designed to lubricate the interface between the tire and the safety support.

22. The mounted assembly according to claim 21, wherein the assembly is provided with the lubricant composition on the radially inner face of the tire opposite the rim.

23. The mounted assembly according to claim 21, wherein at least the radially outer face of the support comprises a rubber composition based on diene elastomer or polyurethane elastomer.

24. The mounted assembly according to claim 21, wherein at least the radially outer face of the support comprises a rubber composition based on thermosetting polyurethane (TPU) or a thermoplastic elastomer (TPE).

25. The mounted assembly according to claim 21, wherein the assembly contains less than 200 g of lubricant composition.

26. The mounted assembly according to claim 25, wherein the assembly contains less than 150 g of lubricant composition.

27. The mounted assembly according to claim 26, wherein the assembly contains less than 100 g of lubricant composition.

28. The use of a lubricant composition according to claim 1, to lubricate an interface between a tire for an automotive vehicle and a safety support fitted on a wheel rim inside the tire.
